(19) United States
(12) Patent Application Publication
(10) Pub. No.: US 2017/0115442 A1
(43) Pub. Date: Apr. 27, 2017

(54) EXTRUDED FIBER OPTIC LIGHT BAR

(71) Applicant: FORD GLOBAL TECHNOLOGIES, LLC, Dearborn, MI (US)

(72) Inventors: Paul Kenneth Dellock, Northville, MI (US); Stuart C. Salter, White Lake, MI (US); Michael A. Musleh, Canton, MI (US); Harry Lobo, Canton, MI (US); Talat Karmo, Waterford, MI (US)

(21) Appl. No.: 14/923,086

(22) Filed: Oct. 26, 2015

(51) Int. Cl. F21V 8/00; B60Q 1/26

(52) U.S. Cl. CPC G02B 6/0008; G02B 6/001; B60Q 1/2696

(57) ABSTRACT

An edge-emitting light bar assembly for a vehicle includes a light-transmitting, edge light-diffusing optical fiber and an at least partially light-transmitting extruded or pultruded coating surrounding the optical fiber to provide a single-layer coated optical fiber. At least one light source is provided for emitting light rays to impinge on an end of the optical fiber. A housing connected to an end of the coated optical fiber and surrounding the at least one light source is provided. The light bar assembly may include a light source disposed at each opposed end of the optical fiber. The single layer coating may include one or more of a colored tint or dye, a frosted material, and a plurality of light reflective or refractive inclusions. Optionally, a portion of the single-layer coating includes an opaque material disposed to direct emitted light rays in a predetermined direction relative to the optical fiber.

### TECHNICAL FIELD

This disclosure relates generally to vehicle exterior lighting. More particularly, the disclosure relates to light bars for use as exterior accents for vehicles, specifically to an extruded or pultruded fiber optic light bar for use, e.g., as distinctive and attractive exterior lighting trim.

### BACKGROUND

It is known, particularly for luxury vehicles, to provide a range of decorative accents and other features to distinguish a vehicle. One such feature is decorative lighting which provides a distinctive vehicular exterior appearance, particularly at night. A popular form of decorative lighting is light bars, which as is known are elongated light displays added to various vehicle elements such as the front headlamps, rear tail lamps and other light elements, along a side of the vehicle, and at other locations. Depending on the specific application, light bars may be configured to define a thickness dimension of from about 6 mm to about 50 mm.

Often, conventional light bars comprise light pipes which transmit light from a light source disposed at an end of the light pipe to emit light throughout the light pipe. Other conventional light bars comprise strings of light sources such as light-emitting diodes (LEDs). Such conventional light bars suffer from a number of disadvantages, including increased cost of manufacture, undesirable thickness, etc. Conventionally designed light bars also often emit undesirable “hot spots” of light, i.e. discrete areas of increased light emission, rather than providing an even transmission of light through and emission of light from the light bar length. Such hot spots particularly tend to exhibit in light bars that are curved beyond a permissible bend radius.

There is accordingly a need in the art for light bars which are affordable to manufacture and therefore which can be included even with lower-cost vehicles, which are not unduly thick, and which do not produce hot spots of light emission even when provided in acute curved configurations. To meet this need, the present disclosure relates to an extruded or pultruded light bar including an optic fiber light transmitter, and to methods for fabricating and post-forming such a light bar. Advantageously, the described devices and methods address the above-summarized problems with conventional light bars, and readily integrate well into conventional automotive and automotive accessory manufacturing processes and facilities.

### SUMMARY

In accordance with the purposes and benefits described herein, in one aspect a light bar for a vehicle is described, comprising a light-transmitting and edge-emitting optical fiber and an at least partially light-transmitting single-layer extruded or pultruded coating surrounding the optical fiber. In embodiments, the single-layer coating defines a cross-sectional geometry selected from one of circular, oval, hexagonal, rectangular, square, triangular, and surface-patterned. In other embodiments, the single layer coating further comprises one or more of a colored tint or dye, a frosted material, and a plurality of light reflective or refractive inclusions. The plurality of light reflective or refractive inclusions are one or more of reflective or refractive particles, mica, glass chips, bubbles, cenospheres, and titanium dioxide particles.

In another aspect, a light bar assembly for a vehicle is described, comprising a coated light-transmitting and edge-emitting optical fiber as described above and at least one light source for emitting light rays to impinge on an end of the optical fiber. A housing is provided connected to an end of the coated optical fiber and surrounding the at least one light source. Optionally, a focusing lens may be disposed in the housing between the at least one light source and the optical fiber. A power source is operatively connected to the at least one light source, which may be any suitable light source including without intending any limitation a light-emitting diode, a laser light-emitting diode, and others.

In embodiments, the light bar assembly includes a light source disposed at each opposed end of the optical fiber. In embodiments, the single-layer coating defines a cross-sectional geometry selected from one of circular, oval, hexagonal, rectangular, square, triangular, and surface-patterned. A portion of the single-layer coating may comprise an opaque material disposed to direct emitted light rays in a predetermined direction relative to the optical fiber.

In embodiments, the single layer coating comprises one or more of a colored tint or dye, a frosted material, and a plurality of light reflective or refractive inclusions. The plurality of light reflective or refractive inclusions may be one or more of reflective or refractive particles, mica, glass chips, bubbles, cenospheres, and titanium dioxide particles.

In yet another aspect, a method for providing an edge-emitting light bar for a vehicle is described, comprising providing a light-transmitting, edge light-diffusing optical fiber and extruding or pultruding an at least partially light-transmitting coating material about the optical fiber to provide a single-layer coated optical fiber. Following the extrusion/pultrusion step, the coated optical fiber may be cut to a desired length.

In embodiments, the method includes a step of extruding or pultruding the coating material through an extruder configured to provide the single-layer coating defining a cross-sectional geometry selected from one of circular, oval, hexagonal, rectangular, square, and triangular, and may also include a step of extruding or pultruding the coating material through an extruder configured to provide the single-layer coating defining a surface pattern. The method may further include a step of providing the coating material comprising one or more of a colored tint or dye, a frosted material, and a plurality of light reflective or refractive inclusions. In embodiments, the method further includes a step of subjecting the cut coated optical fiber to a post-forming process comprising heating sufficiently to soften the coating material, bending the cut coated optical fiber to a desired configuration, and cooling.

In the following description, there are shown and described embodiments of the disclosed extruded or pultruded fiber optic light bar and methods of making. As it should be realized, the devices and methods are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed extruded or pultruded fiber optic light bar and methods of making, and together with the description serve to explain certain principles thereof. In the drawing:

FIG. 1 schematically depicts a light bar according to the present disclosure;

FIG. 2A shows an embodiment of a cross-sectional geometry of the light bar of FIG. 1;

FIG. 2B shows an alternative embodiment of a cross-sectional geometry of the light bar of FIG. 1;

FIG. 2C shows an alternative embodiment of a cross-sectional geometry of the light bar of FIG. 1;

FIG. 2D shows an alternative embodiment of a cross-sectional geometry of the light bar of FIG. 1;

FIG. 2E shows an alternative embodiment of a cross-sectional geometry of the light bar of FIG. 1;

FIG. 2F shows an alternative embodiment of a cross-sectional geometry of the light bar of FIG. 1;

FIG. 2G shows an alternative embodiment of a cross-sectional geometry of the light bar of FIG. 1;

FIG. 2H shows an alternative embodiment of a cross-sectional geometry of the light bar of FIG. 1;

FIG. 3 shows an alternative embodiment of the light bar of FIG. 1;

FIG. 4 shows a perspective cross-sectional view of the light bar of FIG. 1;

FIG. 5 depicts an extrusion/pultrusion machine assembly; and

FIG. 6 illustrates a method of post-forming a light bar according to the present disclosure.

Reference will now be made in detail to embodiments of the disclosed extruded or pultruded fiber optic light bar and methods of making, examples of which are illustrated in the accompanying drawing figures.

### DETAILED DESCRIPTION

Preliminarily, optical fibers are used for a variety of applications requiring transmission of light over long distances. As is well known, an optical fiber is a flexible filament of very clear light-diffusing glass, often coated with a thin layer of a polymer such as poly-vinyl chloride (PVC) or vinyl to protect the fiber from the elements. When connected to a suitable light source, conventional optical fibers are typically highly efficient in delivering light from a light source over long distances. However, such fibers are not well-suited to forming an extended illumination source such as a light bar, as typically side-scatter of light is limited and/or uneven and so light is not laterally emitted evenly along the length of the optical fiber.

Modified edge-diffusing glass optical fibers including scattering centers placed in the optical fiber core are also known. As light passes through the fiber, it encounters the scattering centers which scatter light through the fiber edges and provide efficient light emission throughout the length of the fiber, laterally as well as length-wise. A representative edge-diffusing optical fiber is marketed by Corning®, Inc. under the brand Fibrance®. Such fibers are typically very thin (on the order of 0.5 mm or less in diameter) and lack the stiffness required to create a light bar, and as such are unsuited for use as light bars and further by their fragility are difficult to incorporate into vehicle manufacturing/assembly processes and equipment. While multiple fibers could be bundled to provide a desired thickness dimension, this solution would come at a prohibitive cost.

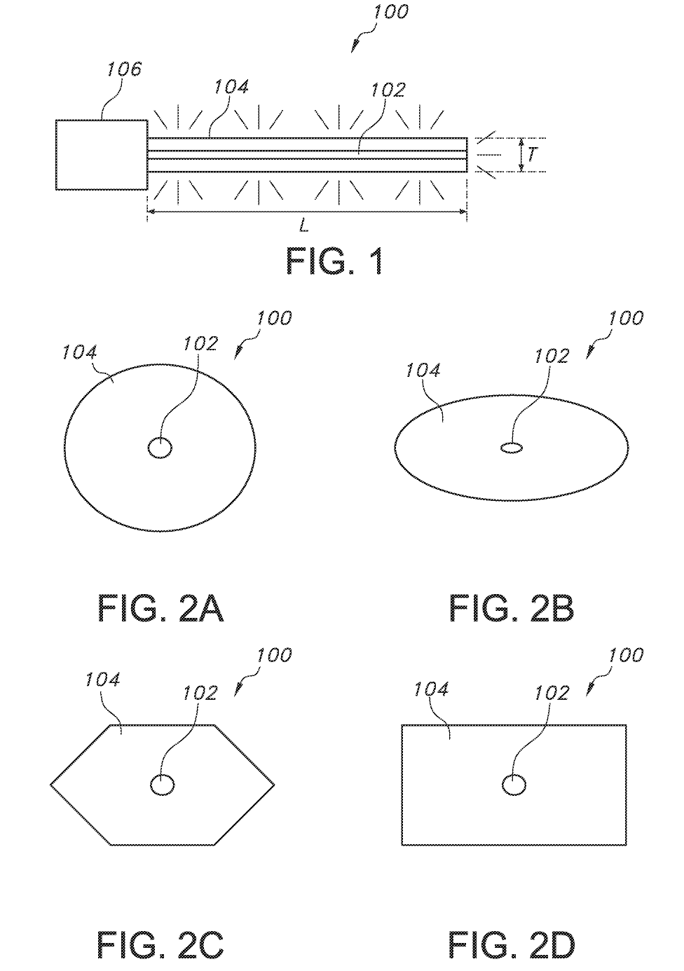

To solve this and other problems, the present disclosure provides an extruded or pultruded light bar or rod 100 (see FIG. 1) comprising an edge-diffusing optical fiber 102 and a single-layer coating 104 made of a suitable light-diffusing clear or translucent material. The optical fiber 102 is operatively connected to a suitable light source 106 which, when activated, emits light into the optical fiber 102 for transmission through and side scattering emission from an entire length L of the light bar 100. Any suitable light source 106 is contemplated for use, including without intending any limitation LEDs, laser LEDs, and others.

In embodiments, a coating 104 may be provided having a thickness dimension T of between from about 6 mm to about 50 mm. However, the skilled artisan will appreciate that the coating 104 thickness may be provided at less than or greater than this thickness dimension range in accordance with the particular application proposed for the light bar 100, the required property of durability of the light bar 100, the degree of flexibility required for the light bar 100, etc.

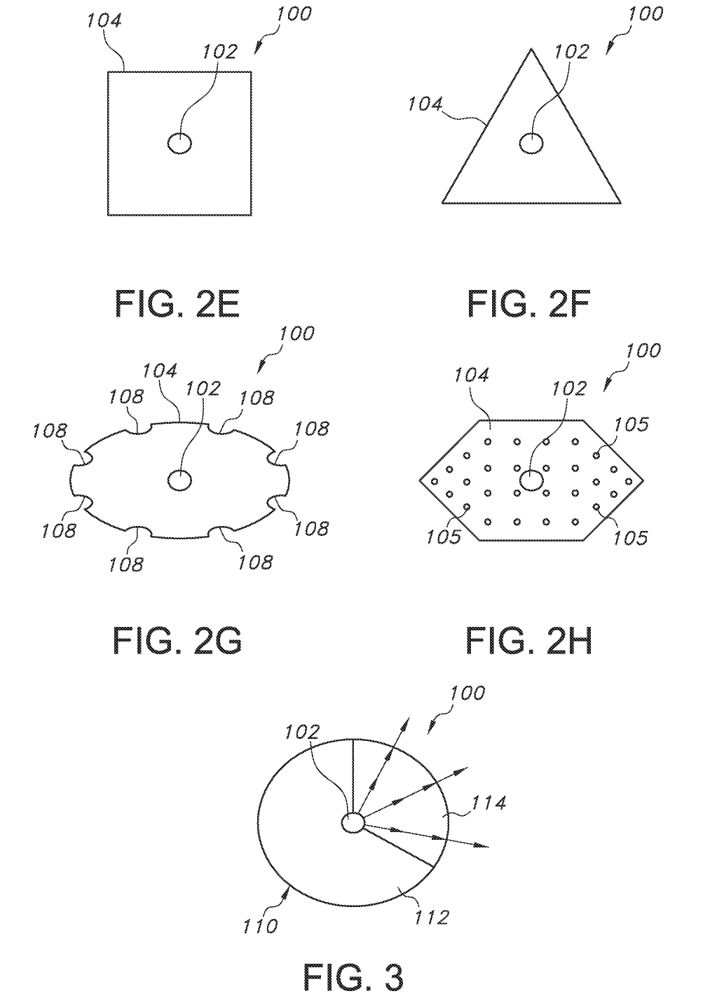

It is further contemplated to provide coatings 104 having a variety of cross-sectional geometries, including without limitation cylindrical (FIG. 2A), oval (FIG. 2B), hexagonal (FIG. 2C), rectangular (FIG. 2D), square (FIG. 2E), triangular (FIG. 2F) and others. As will readily be appreciated, providing such differing cross-sectional geometries will result in an alteration of the pattern of light diffusion therethrough. Moreover, different cross-sectional geometries may be more or less suited to different applications, in accordance with the cross-sectional geometry of the portion of a vehicle at which the light bar 100 will be installed. So, if for example a light bar is to be installed in a groove having a rectangular cross-sectional geometry, the light bar 100 of FIG. 2D might be most appropriate and could be specifically manufactured and installed with minimal post-manufacture modification.

Still more, it is contemplated to provide coatings 104 including surface patterns 108 such as fluting (FIG. 2G) and others during the extrusion process for the coating 104. As will be appreciated, such surface patterns provide multiple desirable functions, for example obscuring the optical fiber 102 from view, further altering a dispersion pattern of light from the optical fiber 102 through the coating 104, etc.

As will be readily appreciated by the skilled artisan, the above-described cross-sectional geometries and/or surface patterns may be provided in coatings 104 by the simple expedient of utilizing a suitably configured extruder when manufacturing a light bar 100. So, for example, an extruder having an oval cross-sectional shape could be used for the light bar 100 of FIG. 2B, an extruder having a square cross-sectional shape could be used for the light bar 100 of FIG. 2D, etc.

In alternative embodiments, it is contemplated to provide the light bar coating 104 by way of a molding process utilizing the optical fiber 102 as a molding insert. Without intending any limitation, a variety of molding processes are contemplated, including injection molding, co-injection molding, and compression molding.

A wide variety of plastic and/or polymer materials are contemplated for use in providing the coating 104. As non-limiting examples, a variety of acrylic materials, polycarbonate materials, resins, clear cross-linked silicon, talc-filled thermoplastic polyolefin (TPO), and others are suitable for providing of the coating 104 and are contemplated for use.

In embodiments, optically clear or fully or partially frosted materials are contemplated to provide the coating 104. Likewise, in embodiments fully or partially tinted materials are contemplated to provide the coating 104. In still other embodiments, inclusion of reflective or refractive, or partially reflective or refractive materials or structures is contemplated to include in the coating 104 (see FIG. 2H). As non-limiting examples, partially reflective/refractive inclusions 105 such as mica, glass chips, bubbles, cenospheres, titanium dioxide, and others may be admixed with the coating material prior to providing the extruded coating 104. As will be appreciated, inclusion of such materials in an extruded coating 104 changes the pattern of light dispersion throughout the light bar 100, creating a glow or birefringent effect.

Still yet more, it is contemplated to provide a light bar 100 having a composite coating comprising an opaque portion whereby light transmission is prevented through a portion thereof. As will be appreciated, by this expedient light emitted from the optical fiber 102 may be shaped and/or redirected as desired. This is illustrated in FIG. 3, representatively illustrating a cross-section of a light bar 100 having a composite coating 110 including an opaque portion 112 which blocks transmission of light therethrough, and a clear, translucent, or semi-opaque portion 114 through which light is transmitted (see arrows). As will be appreciated, by this structure light is emitted only in a desired direction, and thus for example light could be emitted only in a vehicle-outward direction rather than wasting light by emitting it in a vehicle-inward direction. The skilled artisan will readily understand that such a composite coating 110 may be provided by co-extrusion/co-pultrusion of a suitably opaque coating material and a clear, translucent, or semi-opaque material to coat an optical fiber 102.

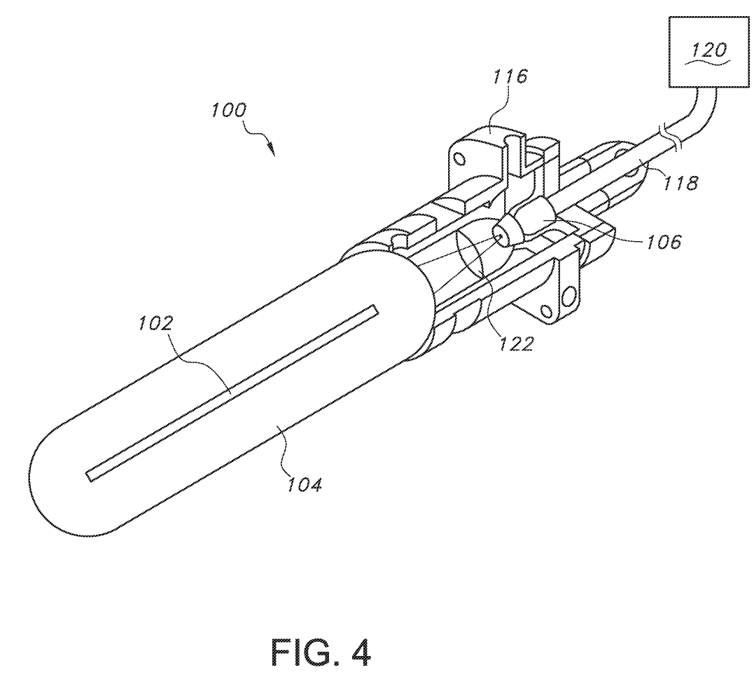

A representative embodiment of a finished extruded or pultruded light bar 100 including a light source 106 is shown in FIG. 4. As described above, the light bar includes an optical fiber 102 and a coating 104 attached at an end to a housing 116 which may be fabricated of plastic, metal, or any other suitable material. The light source 106, in the depicted embodiment being a laser LED, is secured in the housing 116 whereby light rays emitted from the light source will impinge upon the optic fiber 102 to be transmitted therethrough and emitted therefrom. As will be appreciated, use of laser or other LEDs is advantageous in that the intensity of emitted light can be easily controlled and altered, whereby the finished light bar 100 can emit a range of light intensities from a gentle glow to a harsh bright light. Wiring 118 is operatively connected to the light source 106, and extends from an end of the housing opposite that to which the optical fiber 102/coating 104 are attached, leading to a suitable power source 120.

In an embodiment, a focusing lens 122 may be disposed in the housing 116 between the light source 106 and the optical fiber 102, to focus light emitting from the light source onto the optical fiber. As will be appreciated, the light source 106 may be disposed at one end of the optical fiber 102/coating 104 length, or at both ends (embodiment not shown) in accordance with the length of the light bar 100 through which light is to be transmitted and emitted. For very long light bars 100, disposing light sources 106 at both ends of the optical fiber 102/coating 104 may be desirable to ensure an even light transmission/emission throughout the entire length of the light bar 100.

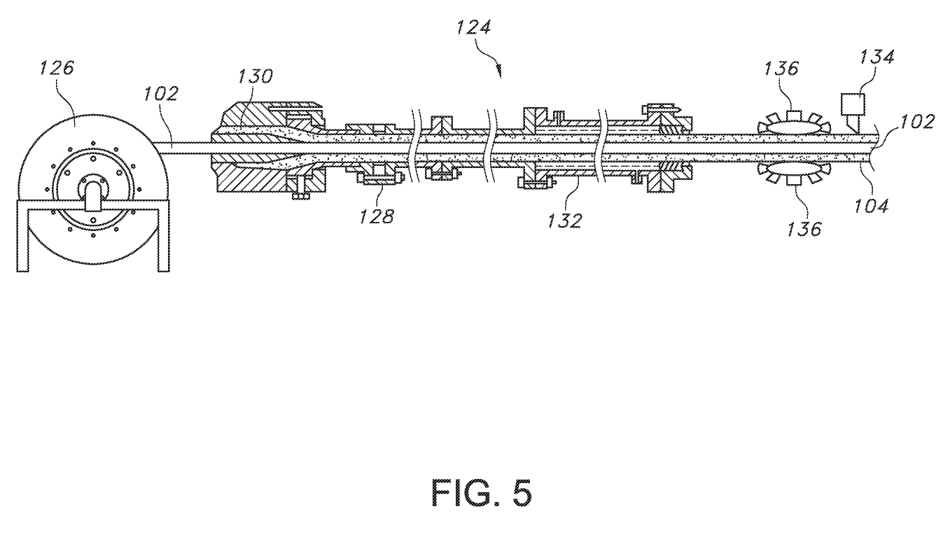

FIG. 5 depicts a representative extruder/pultruder assembly 124 for fabricating a coated optical fiber 102 as described above. As shown, an optical fiber 102 is fed from a spool 126 into an extruder 128. Simultaneously, a suitable coating material 130 is fed into the extruder 128 whereby the described coating 104 is extruded around the optical fiber 102 in a desired shape as described above. As described, the coating material 130 may be a material that is optically clear, fully or partially frosted, fully or partially tinted, or may have inclusions 105 admixed therein, all to alter the scatter and/or emission of light therethrough.

The coated optical fiber 102 passes through a cooling/forming portion 132 of the extruder 128 to cool the coating 104 into a final shape. Next, the optical fiber 102/cooled coating 104 is cut to a desired length, such as by an automated cut-off saw 134 or other suitable knife. Reciprocating pull-blocks 136 may optionally be included to pull the optical fiber 102/cooled coating 104 from the extruder 128 to the cut-off saw 132.

As will be appreciated, the optical fiber 102/cooled coating 104 lengths fabricated as described above are provided in a substantially linear configuration on exiting the extruder/pultruder assembly 124. However, in many if not most vehicle applications, light bars 100 having at least some portion describing a curved or bent configuration are necessary in order to conform to vehicle element configurations, for example headlights, curved or scalloped vehicle body parts, and the like. To solve this problem, the present disclosure contemplates a post-forming process for providing a light bar 100 having a curved configuration.

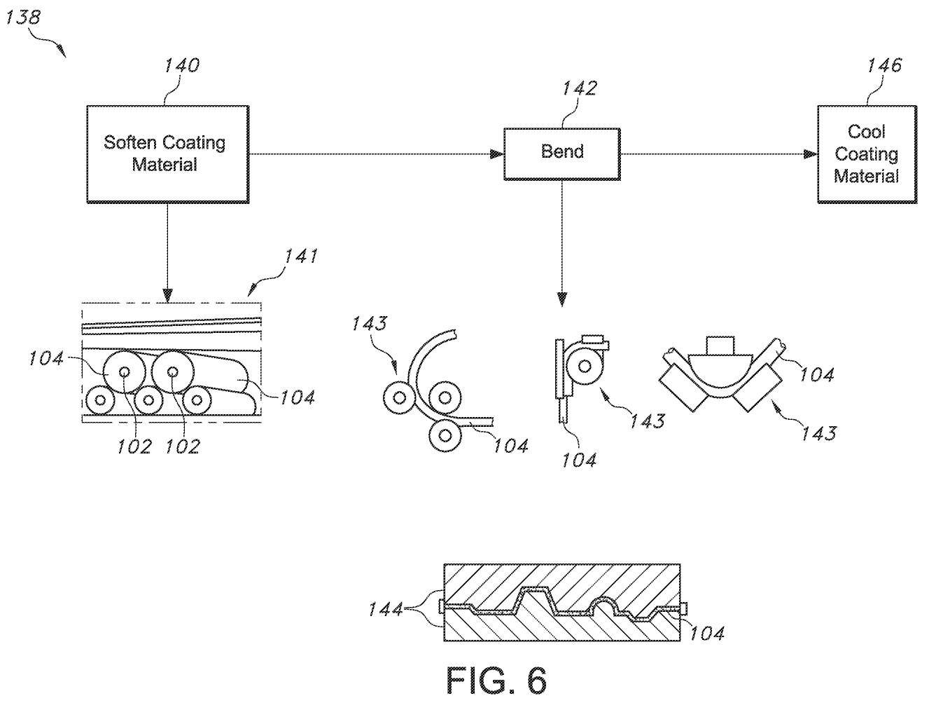

With reference to FIG. 6, a post-forming process 138 for a light bar 100 is illustrated. At step 140, a length of optical fiber 102/cooled coating 104 is heated in, for example, a suitable oven 141 to soften the material of the coating 104. As will be appreciated, sufficient heat is applied to soften the material without melting, and specific temperatures will be applied in accordance with the specific physical properties (melting point) of the material of the coating 104.

Next, at step 142 the softened optical fiber 102/coating 104 is formed into a desired shape. A number of processes are suitable to this step of forming. For example, for simpler curved configurations, softened optical fiber 102/coating 104 may simply be bent to the desired curvature, such as by conventional pipe-bending equipment 143 as is known in the art. For more complex configurations the softened optical fiber 102/coating 104 may be compressed between matched dies 144 to provide a thermoformed piece in a desired configuration.

Once the softened optical fiber 102/coating 104 has been formed to the desired configuration, in step 146 the formed coating 104 may simply be allowed to cool to harden and retain that desired configuration.

By the above-described extruded or pultruded light bar 100, significant advantages are realized over conventional light bar technology. Because optical fibers are more efficient at transmitting light over long distances compared to all-plastic light bars, a consistent, even lighting emission pattern without hot spots is realized along an entire length of the light bar 100. In turn, very efficient lighting can be provided using only a single light source 106, or for very long light bars 100 two light sources 106 disposed at opposite ends of the light bar 100 as described above. In turn, the described extrusion/pultrusion process can be performed at a relatively reduced cost and readily integrated into an automotive or automotive accessory manufacturing facility. Linear light bars 100 or light bars 100 having even complex curvatures can be easily provided for a number of automotive applications. In turn, lighting color, intensity, scatter, diffusion, etc. can be easily altered by simply altering the materials used in fabricating the light bar 100 as described to provide a unique appearance to the light bar 100. Significant material, component, and equipment cost savings are realized.

Obvious modifications and variations are possible in light of the above teachings. All such modifications and variations are within the scope of the appended claims when interpreted in accordance with the breadth to which they are fairly, legally and equitably entitled.

What is claimed:

1. A light bar for a vehicle, comprising:
a light-transmitting and edge-emitting optical fiber; and
an at least partially light-transmitting single-layer extruded or pultruded coating surrounding the optical fiber.

2. The light bar of claim 1, wherein the single-layer coating defines a cross-sectional geometry selected from one of circular, oval, hexagonal, rectangular, square, triangular, and surface-patterned.

3. The light bar of claim 1, wherein the single layer coating comprises one or more of a colored tint or dye, a frosted material, and a plurality of light reflective or refractive inclusions.

4. The light bar of claim 4, wherein the plurality of light reflective or refractive inclusions are selected from one or more of reflective or refractive particles, mica, glass chips, bubbles, cenospheres, and titanium dioxide particles.

5. A light bar assembly for a vehicle, comprising:
a light-transmitting and edge-emitting optical fiber;
an at least partially light-transmitting extruded or pultruded coating surrounding the optical fiber to provide a single-layer coated optical fiber;
at least one light source for emitting light rays to impinge on an end of the optical fiber; and
a housing connected to an end of the coated optical fiber and surrounding the at least one light source.

6. The assembly of claim 5, further including a focusing lens disposed in the housing between the at least one light source and the optical fiber.

7. The assembly of claim 5, further including a power source operatively connected to the at least one light source.

8. The assembly of claim 5, including a light source disposed at each opposed end of the optical fiber.

9. The assembly of claim 5, wherein the single-layer coating defines a cross-sectional geometry selected from one of circular, oval, hexagonal, rectangular, square, triangular, and surface-patterned.

10. The assembly of claim 5, wherein the at least one light source is a laser light-emitting diode or a light-emitting diode.

11. The assembly of claim 5, wherein a portion of the single-layer coating comprises an opaque material disposed to direct emitted light rays in a predetermined direction relative to the optical fiber.

12. The assembly of claim 5, wherein the single layer coating comprises one or more of a colored tint or dye, a frosted material, and a plurality of light reflective or refractive inclusions.

13. The assembly of claim 12, wherein the plurality of light reflective or refractive inclusions are selected from one or more of reflective or refractive particles, mica, glass chips, bubbles, cenospheres, and titanium dioxide particles.

14. A vehicle including the assembly of claim 5.

15. A method for providing an edge-emitting light bar for a vehicle, comprising:
providing a light-transmitting and edge-emitting optical fiber;
extruding or pultruding an at least partially light-transmitting coating material about the optical fiber to provide a single-layer coated optical fiber; and
cutting the coated optical fiber to a desired length.

16. The method of claim 15, including extruding or pultruding the coating material through an extruder configured to provide the single-layer coating defining a cross-sectional geometry selected from one of circular, oval, hexagonal, rectangular, square, and triangular.

17. The method of claim 16, further including extruding or pultruding the coating material through an extruder configured to provide the single-layer coating defining a surface pattern.

18. The method of claim 15, including providing the coating material comprising one or more of a colored tint or dye, a frosted material, and a plurality of light reflective or refractive inclusions.

19. The method of claim 18, including selecting the plurality of light reflective or refractive inclusions from one or more of reflective or refractive particles, mica, glass chips, bubbles, cenospheres, and titanium dioxide particles.

20. The method of claim 15, further including subjecting the cut coated optical fiber to a post-forming process comprising heating sufficiently to soften the coating material, bending the cut coated optical fiber to a desired configuration, and cooling.
